(19) United States
(12) Patent Application Publication
(10) Pub. No.: US 2025/0179957 A1
(43) Pub. Date: Jun. 5, 2025

(54) SYSTEM FOR PASSING A DRIVESHAFT BETWEEN HAZARDOUS AND NONHAZARDOUS ENVIRONMENTS, AND METHOD

(71) Applicant: Baker Hughes Oilfield Operations LLC, Houston, TX (US)

(72) Inventors: Brent Naizer, Tomball, TX (US); Todd Venable, Houston, TX (US)

(21) Appl. No.: 18/529,593

(22) Filed: Dec. 5, 2023

(51) Int. Cl. F02B 77/08; F02B 63/06

(52) U.S. Cl. CPC F02B 77/085; F02B 63/06

(57) ABSTRACT

A system for passing driveshaft between hazardous and nonhazardous environments includes a first gas tight seal disposed in a partition between the hazardous and nonhazardous environments, a second gas tight seal in the partition between the hazardous and nonhazardous environments, the first seal and second seal defining a volume therebetween, a driveshaft passing between the hazardous and nonhazardous environments, the driveshaft sealed to the first and second seals, and a purge and pressure device operably connected to the volume. A method for operating a system with a driveshaft inside a hazardous environment with a drive in a nonhazardous environment includes disposing a driveshaft through a first and a second gas tight seal sealedly disposed in a partition between the hazardous and nonhazardous environments, the first seal and second seal defining a volume therebetween, and supplying a preload pressure in the volume with a purge and pressure device.

### BACKGROUND

Material processing can sometimes be difficult to accomplish due to various environmental considerations of the various equipment used. Some equipment can be exposed to some environments while other equipment cannot. This may be for reasons related to the deleterious nature of an environment to equipment or to conditions that may occur in the larger environment if a hazardous material is allowed to contact a particular piece of equipment. The art is always receptive to alternate systems and methods.

### SUMMARY

An embodiment of a system for passing driveshaft between hazardous and nonhazardous environments comprising a first gas tight rotatable seal disposed sealedly disposed in a partition between the hazardous and nonhazardous environments, a second gas tight rotatable seal disposed sealedly disposed in the partition between the hazardous and nonhazardous environments, the first seal and second seal being spaced from one another to define a volume therebetween, a rotatable driveshaft passing between the hazardous and nonhazardous environments, the driveshaft sealed to each of the first and second seals, and a purge and pressure device operably connected to the volume.

An embodiment of a method for operating a system with a driveshaft inside a hazardous environment with a drive in a nonhazardous environment, including disposing a driveshaft through a first gas tight rotatable seal sealingly connected to the driveshaft and sealedly disposed in a partition between the hazardous and nonhazardous environments, disposing the driveshaft through a second gas tight rotatable seal sealingly connected to the driveshaft and sealedly disposed in the partition between the hazardous and nonhazardous environments, the first seal and second seal being spaced from one another to define a volume therebetween, and supplying a preload pressure in the volume with a purge and pressure device.

### BRIEF DESCRIPTION OF THE DRAWINGS

The following descriptions should not be considered limiting in any way. With reference to the accompanying drawings, like elements are numbered alike:

FIG. 1 is a schematic representation of a system for passing a driveshaft between hazardous and nonhazardous environments; and

FIG. 2 is a cross sectional view of a portion of FIG. 1.

### DETAILED DESCRIPTION

A detailed description of one or more embodiments of the disclosed apparatus and method are presented herein by way of exemplification and not limitation with reference to the Figures.

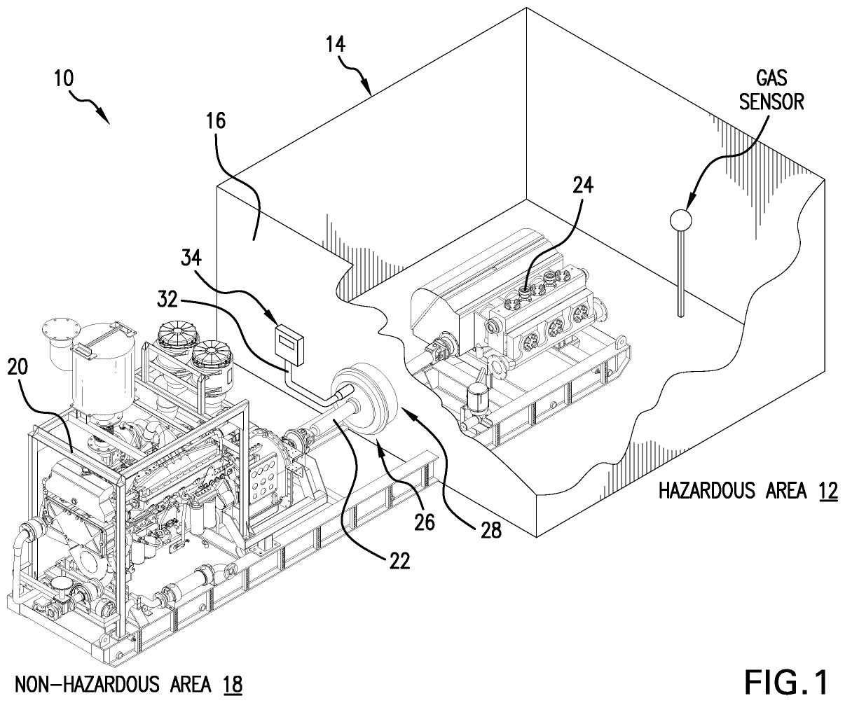

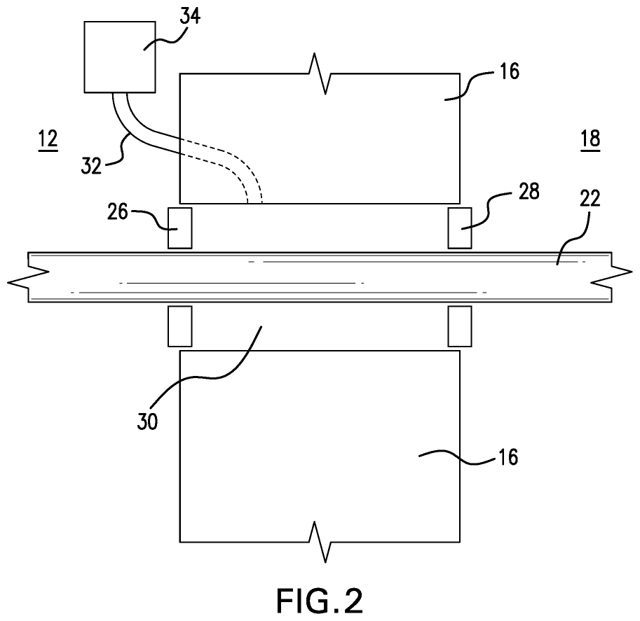

Referring to FIGS. 1 and 2, a system 10 is illustrated. The system 10 includes a hazardous environment 12, which is illustrated as contained within an enclosure 14 but it is to be understood that the enclosure is not a limiting concept. There need only be a partition 16, which in the illustrated case is a part of the enclosure 14 but in other cases might be something else. Suffice it to say that the partition 16 is configured to prevent the hazardous environment 12 from mixing with a nonhazardous environment 18. For context, FIGS. 1 and 2 include an internal combustion engine 20 that may be a diesel engine in some iterations. The engine is needed to rotate a driveshaft 22 that is then used to turn a device 24 such as a pump. It will be appreciated that the device 24 is in the hazardous environment 12 while the engine 20 is not. The driveshaft 22 penetrates the partition 16 and hence creates a potential path for escape of the hazardous environment 12 into the nonhazardous environment 18. Such conditions are not tolerated in the industry. The inventors hereof developed a system to allow this configuration to be operated in a controlled manner. The system further includes a first gas tight rotatable seal 26 that is disposed sealedly in the partition 16 between the hazardous 12 and nonhazardous 18 environments. Seal 26 is commercially available from Simplex Americas LLC, Hamburg, Germany and known as Seal type SC3 ZBS-D-2. Further, a second gas tight rotatable seal 28 is disposed sealedly in the partition 16 between the hazardous 12 and nonhazardous 18 environments. Seal 28 is also commercially available from Simplex Americas LLC and known as Seal type SC3 ZBS-D-2. The first seal 26 and second seal 28 are spaced from one another in the partition 16 to define a volume 30 therebetween that is a contained volume.

Accessing the volume 30 is a conduit 32 that leads to a purge and pressure device 34. Purge and pressure device 34 is commercially available from Expo Technologies, Twinsburg, Ohio. The device 34 is configured to introduce a preload pressure to volume 30 of about 3 to about 8 pounds per square inch (PSI) in an embodiment. Device 34 also includes a sensor to monitor the pressure in volume 30 that will allow the device 34 to maintain the preload pressure that was selected even if a small amount of leaking occurs. Further, however, the device 34 is programable with a threshold value of about one PSI, for example, for pressure loss over a selected time depending upon the particular construction of the device and design accepted parameters at which the loss rate is considered suboptimal and the device 34 will then shut down the entire system 10 until repairs have been made to bring potential leakage from volume 30 to a rate that is below that of the threshold.

A method for operating a system with a driveshaft inside a hazardous environment with a drive in a nonhazardous environment is enabled by using the system described above. The seals 26 and 28 are installed in the partition 16 and the driveshaft disposed therein with the seals sealed to the partition 16 and to the driveshaft 22. The method includes monitoring the preload pressure in the volume 30 and taking either an action of replenishing the pressure through device 34 or shutting down the system 10 if the leakage rate exceeds a selected threshold.

Set forth below are some embodiments of the foregoing disclosure:

Embodiment 1: A system for passing driveshaft between hazardous and nonhazardous environments includes a first gas tight rotatable seal disposed sealedly disposed in a partition between the hazardous and nonhazardous environments, a second gas tight rotatable seal disposed sealedly disposed in the partition between the hazardous and nonhazardous environments, the first seal and second seal being spaced from one another to define a volume therebetween, a rotatable driveshaft passing between the hazardous and nonhazardous environments, the driveshaft sealed to each of the first and second seals, and a purge and pressure device operably connected to the volume.

Embodiment 2: The system as in any prior embodiment, wherein the purge and pressure device includes a pump and a sensor to preload a pressure in the volume and monitor the volume pressure.

Embodiment 3: The system as in any prior embodiment, wherein the preload pressure is about 3 to about 8 pounds per square inch (PSI).

Embodiment 4: The system as in any prior embodiment, wherein the purge and pressure device maintains the preload pressure with added fluid volume until a threshold loss of pressure over time is exceeded.

Embodiment 5: The system as in any prior embodiment, wherein the threshold is one pound per square inch (PSI).

Embodiment 6: The system as in any prior embodiment, further including a sensor in the hazardous environment.

Embodiment 7: The system as in any prior embodiment, wherein the nonhazardous environment includes an internal combustion engine and the hazardous environment includes a flammable substance.

Embodiment 8: A method for operating a system with a driveshaft inside a hazardous environment with a drive in a nonhazardous environment includes disposing a driveshaft through a first gas tight rotatable seal sealingly connected to the driveshaft and sealedly disposed in a partition between the hazardous and nonhazardous environments, disposing the driveshaft through a second gas tight rotatable seal sealingly connected to the driveshaft and sealedly disposed in the partition between the hazardous and nonhazardous environments, the first seal and second seal being spaced from one another to define a volume therebetween, and supplying a preload pressure in the volume with a purge and pressure device.

Embodiment 9: The method as in any prior embodiment, further including monitoring the preload pressure in the volume with a sensor.

Embodiment 10: The method as in any prior embodiment, further comprising comparing the sensor reading to a threshold for pressure loss over time.

Embodiment 11: The method as in any prior embodiment, further comprising shutting down the system if the threshold is exceeded.

Embodiment 12: The method as in any prior embodiment, further including adding pressure to the volume in the event that preload pressure in the volume falls.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system for passing driveshaft between hazardous and nonhazardous environments, comprising:
a first gas tight rotatable seal disposed sealedly disposed in a partition between the hazardous and nonhazardous environments;
a second gas tight rotatable seal disposed sealedly disposed in the partition between the hazardous and nonhazardous environments, the first seal and second seal being spaced from one another to define a volume therebetween;
a rotatable driveshaft passing between the hazardous and nonhazardous environments, the driveshaft sealed to each of the first and second seals; and
a purge and pressure device operably connected to the volume.

2. The system as claimed in claim 1, wherein the purge and pressure device includes a pump and a sensor to preload a pressure in the volume and monitor the volume pressure.

3. The system as claimed in claim 2, wherein the preload pressure is about 3 to about 8 pounds per square inch (PSI).

4. The system as claimed in claim 1, wherein the purge and pressure device maintains the preload pressure with added fluid volume until a threshold loss of pressure over time is exceeded.

5. The system as claimed in claim 4, wherein the threshold is one pound per square inch (PSI).

6. The system as claimed in claim 1, further including a sensor in the hazardous environment.

7. The system as claimed in claim 1, wherein the nonhazardous environment includes an internal combustion engine and the hazardous environment includes a flammable substance.

8. A method for operating a system with a driveshaft inside a hazardous environment with a drive in a nonhazardous environment, comprising:
disposing a driveshaft through a first gas tight rotatable seal sealingly connected to the driveshaft and sealedly disposed in a partition between the hazardous and nonhazardous environments;
disposing the driveshaft through a second gas tight rotatable seal sealingly connected to the driveshaft and sealedly disposed in the partition between the hazardous and nonhazardous environments, the first seal and second seal being spaced from one another to define a volume therebetween; and
supplying a preload pressure in the volume with a purge and pressure device.

9. The method as claimed in claim 8, further including monitoring the preload pressure in the volume with a sensor.

10. The method as claimed in claim 9, further comprising comparing the sensor reading to a threshold for pressure loss over time.

11. The method as claimed in claim 10, further comprising shutting down the system if the threshold is exceeded.

12. The method as claimed in claim 8, further including adding pressure to the volume in the event that preload pressure in the volume falls.
